(19) United States
(12) Patent Application Publication
(10) Pub. No.: US 2018/0011818 A1
(43) Pub. Date: Jan. 11, 2018

(54) Webpage Update Method And Apparatus

(71) Applicant: GUANGZHOU UCWEB COMPUTER TECHNOLOGY CO., LTD., Guangzhou (CN)

(72) Inventor: Chuang ZHAO, Guangzhou (CN)

(21) Appl. No.: 15/531,126

(22) PCT Filed: Aug. 10, 2015
(86) PCT No.: PCT/CN2015/086480

§ 371 Date: May 26, 2017

(30) Foreign Application Priority Data
Nov. 27, 2014 (CH) 201410705310.3

(51) Int. Cl. G06F 17/21; G06F 17/30; G06F 17/22

(52) U.S. Cl. CPC G06F 17/212; G06F 17/2205; G06F 17/30896

(57) ABSTRACT

A webpage update method and apparatus includes setting a dynamic area according to a visible area of a browser, then using an area, corresponding to the dynamic area, in a target webpage as an area to be rendered, storing webpage update content generated in the area to be rendered in a first preset storage area, so as to read, at one time, the webpage update content in the first preset storage area, to complete rendering of the area to be rendered, thereby ensuring that the content currently displayed in the visible area is updated content. Meanwhile, webpage update content generated in an area other than the area to be rendered is stored in a second preset storage area, and rendering of the corresponding area is temporarily not performed, so that a working amount of a rendering operation can be reduced.

The present invention claims priority to the Chinese Patent Application filed with the Chinese Patent Office on Nov. 27, 2014 with an application No. 201410705310.3 and entitled Webpage update method and apparatus, which is incorporated in its entirety herein by reference.

### TECHNICAL FIELD

The present invention relates to the field of webpage processing technologies, and in particular, to a webpage update method and apparatus.

### BACKGROUND ART

If a typesetting of a target webpage in the process that a browser presents the webpage, e.g. a smart terminal requests to open a new page, a dynamic element (e.g. moving pictures in the gif format, CSS animation, etc.) exists in the current page, corresponding webpage update contents would usually be generated. The browser needs to render these webpage update contents into the target webpage to replace the original contents, thereby realizing webpage update.

A common browser employs the following webpage update method: traversing all nodes of a rendering tree corresponding to the target webpage through the browser kernel, so as to determine whether each node needs to generate webpage update contents, and storing all webpage update contents acquired from traversing to a preset storage area; subsequently, reading sequentially the webpage update contents in the above preset storage area through a browser shell, and performing, according to the read webpage update contents, rendering on the target webpage.

According to the above webpage update method, when there are relatively high quantities of webpage update contents in the target webpage, e.g. there is a plurality of moving pictures in the gif format in the target webpage, it takes a long time for the browser to complete the rendering of the whole target webpage, and consequently, the target webpage update speed is low, such that the dynamic element in the webpage stops and moves, making it less smooth and impossible to rapidly present contents of the webpage that is browsed by a user.

### SUMMARY OF THE INVENTION

To overcome the problems in the prior art, the present application provides a webpage update method and apparatus.

According to a first aspect of the present application, a webpage update method is provided, said method comprising:

determining a dynamic area according to a visible area of a browser;

determining an area, corresponding to the dynamic area, in a target webpage as an area to be rendered;

storing webpage update contents corresponding to the area to be rendered into a first preset storage area;

rendering the target webpage according to the webpage update contents stored in the first preset storage area.

Furthermore, said determining a dynamic area according to a visible area of a browser comprises:

determining a relative moving direction between said visible area and said target webpage;

determining an expanded area connected to said visible area according to said relative moving direction and a preset expansion height;

determining an area formed by said visible area and said expanded area to be said dynamic area.

Furthermore, said determining a relative moving direction between said visible area and said target webpage comprises:

establishing a Cartesian coordinate system on the plane on which the target webpage is located;

according to changes of the top boundary coordinate of said visible area in said Cartesian coordinate system, determining a relative moving direction between said visible area and said target webpage.

Furthermore, said determining an area, corresponding to the dynamic area, in the target webpage as an area to be rendered comprises:

dividing said target webpage into a plurality of static blocks;

determining a static block intersecting with said dynamic area as an area to be rendered.

Furthermore, said dividing said target webpage into a plurality of static blocks comprises:

in the height direction of said target webpage, dividing said target webpage into a plurality of static blocks with the same height; alternatively,

in the height direction of said target webpage, dividing said target webpage into a plurality of static blocks with heights that are not all the same.

Furthermore, said webpage update method further comprises: storing said static blocks with an array.

Furthermore, said webpage update method further comprises: storing webpage update contents corresponding to an area other than the area to be rendered in said target webpage into a second preset storage area.

Furthermore, said storing webpage update contents corresponding to the area to be rendered into a first preset storage area comprises:

dividing an area with webpage update contents in said target webpage into a plurality of blocks to be rendered;

storing webpage update contents of a first block to be rendered intersecting with said area to be rendered into said first preset storage area.

Furthermore, said storing webpage update contents corresponding to an area other than the area to be rendered in said target webpage into a second preset storage area comprises:

storing webpage update contents of a block to be rendered other than said first block to be rendered into said second preset storage area.

Furthermore, said webpage update method further comprises:

when relative positions between said dynamic area and said target webpage change, re-determining said area to be rendered;

when a second block to be rendered intersecting with said re-determined area to be rendered exists in the blocks to be rendered corresponding to the webpage update contents stored in said second preset storage area, transferring the webpage update contents corresponding to the second block to be rendered from said second preset storage area to said first preset storage area.

According to a second aspect of the present application, a webpage update device is provided, said device comprising:

a dynamic area setting unit configured to determine a dynamic area according to a visible area of a browser;

a to-be-rendered area determining unit configured to determine an area, corresponding to the dynamic area, in a target webpage as an area to be rendered;

a first update content processing unit configured to store webpage update contents corresponding to the area to be rendered into a first preset storage area, and store webpage update contents corresponding to an area other than the area to be rendered in said target webpage into a second preset storage area;

a target webpage rendering unit configured to render the target webpage according to the webpage update contents stored in the first preset storage area.

Furthermore, said dynamic area setting unit comprises:

a moving direction determining module configured to determine a relative moving direction between said visible area and said target webpage;

an expanded area determining module configured to determine an expanded area connected to said visible area according to said relative moving direction and a preset expansion height;

a dynamic area determining module configured to determine an area formed by said visible area and said expanded area to be said dynamic area.

Furthermore, said moving direction determining module comprises:

a coordinate system establishing sub-module configured to establish a Cartesian coordinate system on the plane on which the target webpage is located;

a relative moving mode determining sub-module configured to determine, according to changes of the top boundary coordinate of said visible area in said Cartesian coordinate system, a relative moving direction between said visible area and said target webpage.

Furthermore, said to-be-rendered area determining unit comprises:

a target webpage dividing module configured to divide said target webpage into a plurality of static blocks;

a to-be-rendered area determining module configured to determine a static block intersecting with said dynamic area as an area to be rendered.

Furthermore, said target webpage dividing module is specifically configured to:

in the height direction of said target webpage, divide said target webpage into a plurality of static blocks with the same height; alternatively,

in the height direction of said target webpage, divide said target webpage into a plurality of static blocks with heights that are not all the same.

Furthermore, said webpage update device further comprises:

a storing module configured to store said static blocks with an array.

Furthermore, said webpage update device further comprises:

a second update content processing unit configured to store webpage update contents corresponding to an area other than the area to be rendered in said target webpage into a second preset storage area.

Furthermore, said first update content processing unit comprises:

an update area dividing module configured to divide an area with webpage update contents in said target webpage into a plurality of blocks to be rendered;

a divided storage control module configured to store webpage update contents of a first block to be rendered intersecting with said area to be rendered into said first preset storage area.

Furthermore, said second update content processing unit is specifically configured to:

store webpage update contents of a block to be rendered other than said first block to be rendered into said second preset storage area.

Furthermore, said webpage update device further comprises:

a to-be-rendered area resetting unit configured to re-determine, when relative positions between said dynamic area and said target webpage change, said area to be rendered;

an update content transferring unit configured to transfer, when a second block to be rendered intersecting with said re-determined area to be rendered exists in the blocks to be rendered corresponding to the webpage update contents stored in said second preset storage area, the webpage update contents corresponding to the second block to be rendered from said second preset storage area to said first preset storage area.

According to a third aspect of the present application, an electronic device is provided, comprising: a processor; and a memory configured to store an instruction executable by said processor;

said memory is configured to store computer executable instructions;

said processor is configured to set a dynamic area according to a visible area of a browser; determine an area, corresponding to the dynamic area, in a target webpage as an area to be rendered; store webpage update contents corresponding to the area to be rendered into a first preset storage area, and store webpage update contents corresponding to an area other than the area to be rendered in said target webpage into a second preset storage area; render the target webpage according to the webpage update contents stored in the first preset storage area.

Furthermore, said processor specifically determines a relative moving direction between said visible area and said target webpage; determines an expanded area connected to said visible area according to said relative moving direction and a preset expansion height; determines an area formed by said visible area and said expanded area to be said dynamic area.

Furthermore, said processor specifically divides said target webpage into a plurality of static blocks; determines a static block intersecting with said dynamic area as an area to be rendered.

Furthermore, said processor specifically divides an area with webpage update contents in said target webpage into a plurality of blocks to be rendered; stores webpage update contents of a first block to be rendered intersecting with said area to be rendered into said first preset storage area, and stores webpage update contents of other blocks to be rendered into said second preset storage area.

Furthermore, said processor is further configured to re-determine, when relative positions between said dynamic area and said target webpage change, said area to be rendered; determine whether a second block to be rendered intersecting with said re-determined area to be rendered exists in the blocks to be rendered corresponding to the webpage update contents stored in said second preset storage area; if said second block to be rendered exists, transfer the webpage update contents corresponding to the second block to be rendered from said second preset storage area to said first preset storage area.

According to a fourth aspect of the present application, a non-transitory computer readable medium is provided, comprising: computer executable instructions, such that, when a computer processor executes said computer executable instructions, said computer executes the webpage update method according to any one of the above.

It can be seen from the above technical solution that the embodiments of the present application first set a dynamic area according to a visible area of a browser, then use an area, corresponding to the dynamic area, in a target webpage as an area to be rendered, and store webpage update contents generated in the area to be rendered into a first preset storage area. Subsequently, the webpage update contents in said first preset storage area are read at one time, and the rendering of the area to be rendered is completed, which ensures that the content displayed in the current visible area is the updated content; meanwhile, webpage update contents generated in an area other than the area to be rendered are stored in a second preset storage area, and rendering of the corresponding area is temporarily not performed, which can reduce the workload of a rendering operation, and improve the rendering efficiency of the area to be rendered, thereby improving update speeds of dynamic elements such as a moving picture or an animation in the visible area, and eliminating a latency phenomenon of dynamic elements moving irregularly due to a slow update speed.

It should be understood that the general description above and the following detailed description are only exemplary and illustrative, which cannot limit the present application.

### BRIEF DESCRIPTION OF THE DRAWINGS

The accompanying drawings herein are incorporated in the description and form a part of the present description. They illustrate embodiments that comply with the present invention, and are used together with the present description to explain the principles of the present invention.

FIG. 1 is a flowchart of a webpage update method according to an exemplary embodiment.

FIG. 2 illustrates the comparison of a target webpage shown in an exemplary embodiment and the actual display of a browser.

FIG. 3 is a flowchart of another webpage update method according to an exemplary embodiment.

FIG. 4 is a schematic diagram of a Cartesian coordinate system based on a target webpage according to an exemplary embodiment.

FIG. 5 is a flowchart of yet another webpage update method according to an exemplary embodiment.

FIG. 6 is a flowchart of yet another webpage update method according to an exemplary embodiment.

FIG. 7 illustrates the time consumption comparison of webpage update processes on the same target webpage according to the prior art and an exemplary embodiment of the present application.

FIG. 8 is a structural block diagram of a webpage update device according to an exemplary embodiment.

FIG. 9 is a structural block diagram of another webpage update device according to an exemplary embodiment.

FIG. 10 is a structural block diagram of yet another webpage update device according to an exemplary embodiment.

FIG. 11 is a structural block diagram of an electronic device according to an exemplary embodiment.

### DETAILED DESCRIPTION OF THE SPECIFIC EMBODIMENTS

Exemplary embodiments will be described in detail with examples thereof illustrated in the accompanying drawings. When the accompanying drawings are mentioned in the following description, identical numerals in different figures represent identical or similar elements, unless otherwise expressed. The implementation modes described in the following exemplary embodiments do not represent all implementation modes that are consistent with the present invention. On the contrary, they are only examples of devices and methods that are consistent with some aspects of the present invention as described in detail in the appended claims.

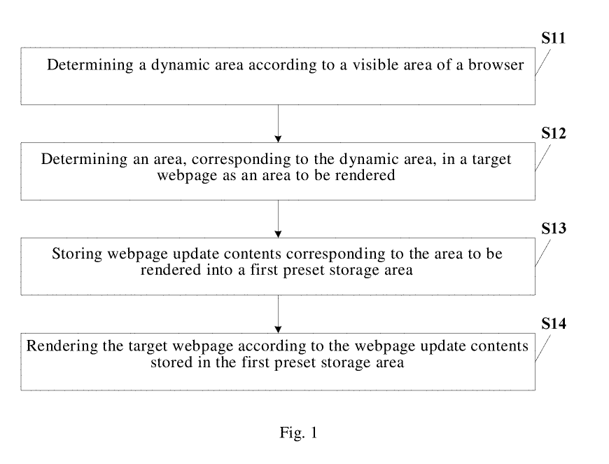

FIG. 1 is a flowchart of a webpage update method according to an embodiment of the present application, said webpage update method being applied to a browser. As shown in FIG. 1, said method comprises the following steps.

S11. determining a dynamic area according to a visible area of a browser.

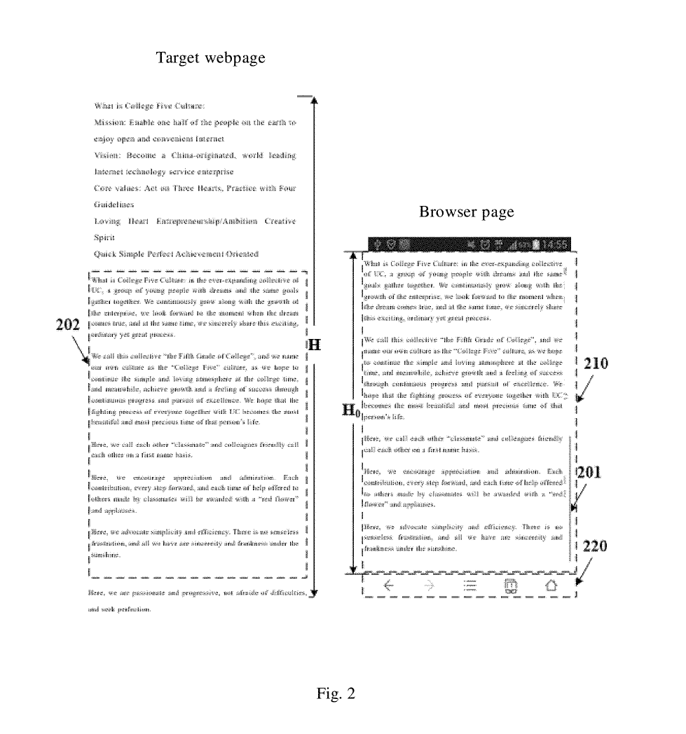

In the comparison of a target webpage and the actual display of a browser as shown in FIG. 2, a browser page mainly comprises two parts: a visible area 210 and a setting area 220; wherein, the setting area 220 displays controls configured to set attributes, such as appearance, webpage display style, etc., of the browser, and the visible area 210 is configured to display the target webpage. When there are many contents to be displayed in the target webpage, the webpage height H after normal typesetting is consequently greater than the height HO of the visible area 210 of the browser, and the target webpage cannot be all displayed in the browser window at the same time; at this moment, a scrollbar 201 is usually provided on a side of the browser window, and the relative positions of the browser window and the target webpage are adjusted by adjusting the position of the scrollbar 201, so as to display different areas of the target webpage. What is displayed in the browser window shown in FIG. 2 is the area 202 in the target webpage.

The dynamic area above comprises the visible area 210 of the browser.

S12. determining an area, corresponding to the dynamic area, in a target webpage as an area to be rendered.

S13. storing webpage update contents corresponding to the area to be rendered into a first preset storage area.

S14. rendering the target webpage according to the webpage update contents stored in the first preset storage area.

It can be seen from the above technical solution that the embodiments of the present application first set a dynamic area according to a visible area of a browser, then use an area, corresponding to the dynamic area, in a target webpage as an area to be rendered, and store webpage update contents generated in the area to be rendered into a first preset storage area. Subsequently, the webpage update contents in said first preset storage area are read at one time, and the rendering of the area to be rendered is completed, which ensures that the content displayed in the current visible area is the updated content; meanwhile, webpage update contents generated in an area other than the area to be rendered are stored in a second preset storage area, and rendering of the corresponding area is temporarily not performed, which can reduce the workload of a rendering operation, and improve the rendering efficiency of the area to be rendered, thereby improving update speeds of dynamic elements such as a moving picture or an animation in the visible area, and eliminating a latency phenomenon of dynamic elements moving irregularly due to a slow update speed.

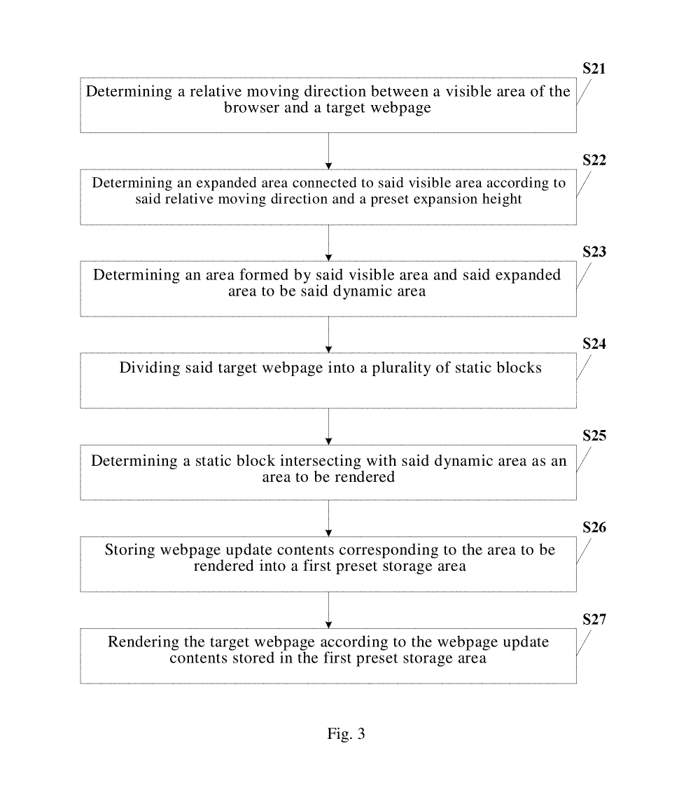

FIG. 3 is a flowchart of a webpage update method according to another embodiment of the present application; said webpage update method is applied to a browser. As shown in FIG. 3, said method comprises the following steps.

S21. determining a relative moving direction between a visible area of the browser and a target webpage.

In the embodiment of the present application, the above relative moving direction can be determined in the following mode:

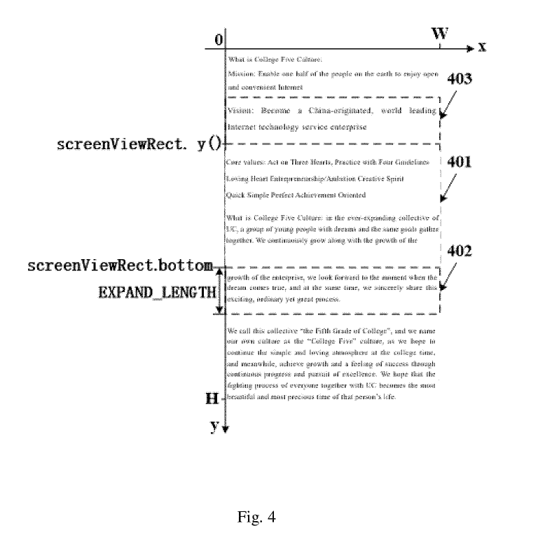

using a variable sd to represent the above relative moving direction; as shown in FIG. 4, establishing a Cartesian coordinate system (i.e. a xy coordinate system) with the upper left corner of the target webpage as the origin, and the positive direction of the y axis of said coordinate system is vertically downward along the target webpage; according to changes of the top boundary coordinate screenViewRect.y of the above visible area 401, determining the above relative moving direction. Namely, if screenViewRect.y increases, it indicates that the visible area 401 moves downwardly relative to the target webpage, then it can be marked that sd=scroll_down. On the contrary, if screenViewRect.y decreases, it indicates that the visible area 401 moves upwardly relative to the target webpage, then it is marked that sd=scroll_up.

S22. determining an expanded area connected to said visible area according to said relative moving direction and a preset expansion height.

The above preset expansion height indicates the height of the expanded area, which can be marked as a constant EXPAND_LENGTH. In the present embodiment, the following format may be used to indicate a rectangular area: Rect: (Rect left boundary coordinate, Rect top boundary coordinate, Rect width, Rect height); wherein, the Rect left boundary coordinate is the horizontal axis coordinate Rect.x of the left top point of Rect, and the Rect top boundary coordinate is the vertical axis coordinate Rect.y of the left top point of Rect.

If sd=scroll_down, then said downward expanded area 402 is set below the visible area; wherein, values of the top boundary coordinate, left boundary coordinate and width of said downward expanded area 402 are the same as the bottom boundary coordinate (screenViewRect.bottom), left boundary coordinate (0) and width of (screenViewRect.width) of the visible area 401, respectively, and the height value of the downward expanded area 402 is the above constant EXPAND_LENGTH; namely, the downward expanded area 402 can be expressed as (0, screenViewRect.bottom, screenViewRect.width, EXPAND_LENGTH).

If sd=scroll_up, then said upward expanded area 403 is set above the visible area; wherein, values of the bottom boundary coordinate, left boundary coordinate and width of said upward expanded area 403 are the same as the top boundary coordinate (screenViewRect.y), left boundary coordinate (0) and width of (screenViewRect.width) of the visible area 401, respectively, and the height value of the upward expanded area 403 is the above constant EXPAND_LENGTH; namely, the upward expanded area 403 can be expressed as (0, screenViewRect. y-EXPAND_LENGTH, screenViewRect.width, EXPAND_LENGTH).

The meaning of the above expanded area is as follows: the area of the target webpage corresponding to the expanded area at the present moment is the area of the target webpage to enter the visible area at the next moment (after scrolling in the above relative moving direction). Therefore, the embodiment of the present application determines an expanded area, i.e. determines an area of the target webpage to enter the visible area.

S23. determining an area formed by said visible area and said expanded area to be said dynamic area.

It can be seen from the step S22 that, if sd=scroll_down, then the above dynamic area (dynamicRect) is an area formed by the visible area 401 and the downward expanded area 402; if sd=scroll_up, then the dynamic area is an area formed by the visible area 401 and the upward expanded area 403.

S24. dividing said target webpage into a plurality of static blocks.

In the present embodiment, the target webpage can be divided in its height direction according to a first preset sub-block length SPLIT_LENGTH to obtain a plurality of static blocks with a width as the width W of the target webpage and a height of SPLIT_LENGTH; in particular, if the total height H of the target webpage is not an exact multiple of SPLIT_LENGTH, then the height of the last obtained static block is the remainder from the division of H by SPLIT_LENGTH (less than SPLIT_LENGTH). In a feasible implementation mode of the present application, the static blocks may be stored through an array splitRect; assuming that the target webpage can be divided into N static blocks, then the i^{th} (i=0, 1, 2, . . . , N−1) static block splitRect[i] from top down in the target webpage can be expressed in the following format:

when i=0, 1, 2, . . . , N−2, splitRect[i]=(0, SPLIT_LENGTH*i, W, SPLIT_LENGTH);

When i=N−1, splitRect[i]=(0,SPLIT_LENGTH*i,W,H-SPLIT_LENGTH*i).

In other embodiments of the present application, the target webpage can certainly be divided into static blocks with heights that are not all the same. In addition, it should be noted that the above steps of determining a dynamic area, i.e. the steps S21 to S23, and the step S24 of dividing the target webpage into static blocks are two parallel operations. There is no order in terms of the execution of the two. Namely, in other feasible embodiments of the present application, the step S24 may be executed at the same time as the execution of the steps S21 to S23, or the step S24 may be executed first, and then the steps S21 to S23 are executed.

S25. determining a static block intersecting with said dynamic area as an area to be rendered.

Determining, when i=0, 1, 2, . . . , N−1, whether splitRect[i] intersects with the above dynamicRect, respectively. If they are intersected, using the corresponding static block as a part of the area to be rendered; namely, the above area to be rendered is a set of all static blocks in the target webpage that intersect with the dynamic area dynamicRect.

S26. storing webpage update contents corresponding to the area to be rendered into a first preset storage area.

S27. rendering the target webpage according to the webpage update contents stored in the first preset storage area.

It can be seen from the above technical solution that the embodiments of the present application first determine an expanded area according to a relative moving direction between the visible area of the browser and the target webpage, then use a combination of the expanded area and the visible area as a dynamic area, and use a target webpage area intersecting with the dynamic area as an area to be rendered, such that said area to be rendered comprises both the target webpage area displayed in the browser at the present moment and a target webpage area to be displayed in the browser; then render the target webpage according to the webpage update contents corresponding to the area to be rendered, namely render the target webpage areas displayed and to be displayed in the browser, while webpage update contents of other areas are temporarily not processed, which can reduce the workload of the rendering operation at the present moment, improve the rendering speed, and also ensure that the target webpages displayed and to be displayed to users are successful rendered, thereby improving the update speed smoothness of contents seen by users.

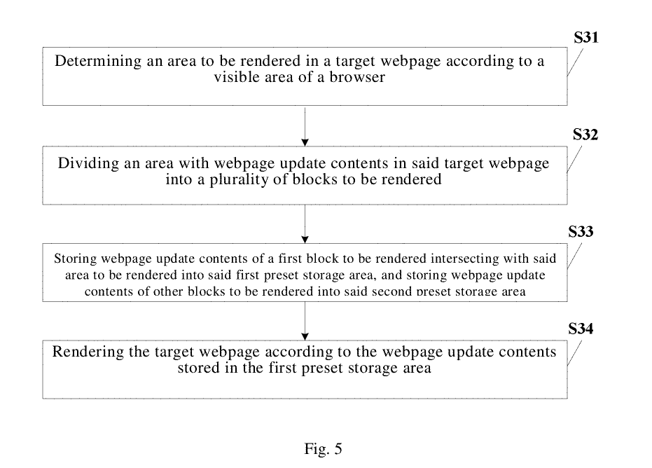

FIG. 5 is a flowchart of yet another webpage update method according to another according to an embodiment of the present application; said method is applied to a browser. Referring to FIG. 5, said webpage update method comprises the following steps.

S31. determining an area to be rendered in a target webpage according to a visible area of a browser.

Specifically, the present embodiment may determine an area to be rendered using the method set forth in the above steps S11 to S12 or steps S21 to S25, which will not be repeated herein.

S32. dividing an area with webpage update contents in said target webpage into a plurality of blocks to be rendered.

By traversing a rendering tree corresponding to the target webpage, it can be determined that an area with webpage update contents exists in the target webpage; the area with webpage update contents can be divided in its height direction according to a second preset sub-block length DIRTY_LENGTH to obtain a plurality of blocks to be rendered with a width as the width of the target webpage and a height of DIRTY_LENGTH; in particular, if the total height H′ of the area with webpage update contents is not an exact multiple of DIRTY_LENGTH, then the height of the last obtained block to be rendered is the remainder from the division of H′ by DIRTY_LENGTH (less than DIRTY_LENGTH).

Referring to the storage form of the static blocks described above, the above blocks to be rendered may also be stored in the form of an array, which will not be repeated herein.

S33. storing webpage update contents of a first block to be rendered intersecting with said area to be rendered into said first preset storage area, and storing webpage update contents of other blocks to be rendered into said second preset storage area.

All blocks to be rendered are determined, sequentially, whether intersecting with the area to be rendered, and if yes, it indicates that said block to be rendered is a first block to be rendered, and the corresponding webpage update contents are stored into a first preset storage area; if no, the corresponding webpage update contents are stored into a second preset storage area; namely, only the first block to be rendered is rendered in the subsequent steps.

S34. rendering the target webpage according to the webpage update contents stored in the first preset storage area.

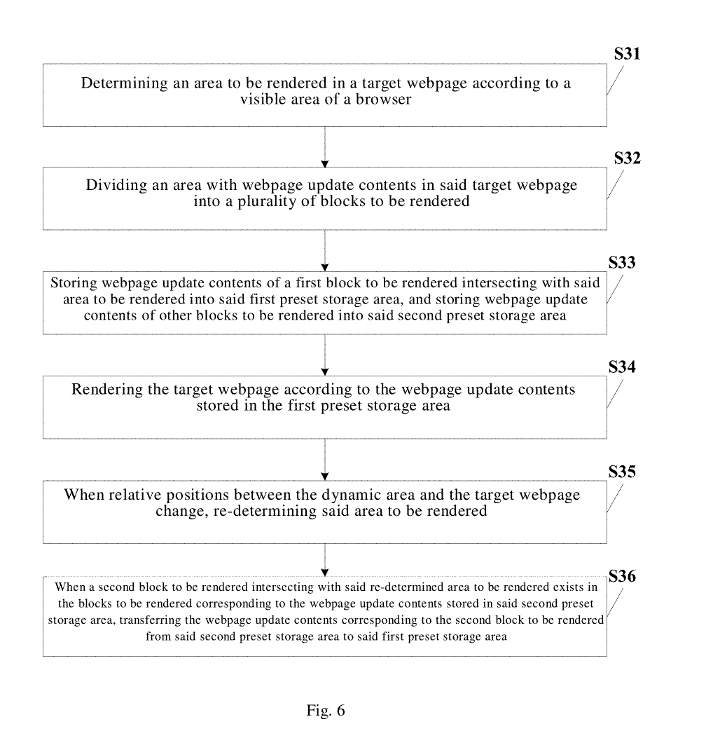

As shown in FIG. 6, based on the webpage update storing method shown in FIG. 5, the webpage update method according to the embodiment of the present application may further comprises the following steps.

S35. when relative positions between the dynamic area and the target webpage change, re-determining said area to be rendered.

Relative positions between the dynamic area and the target webpage change, which means the target webpage is scrolled (i.e. the position change of the scrollbar 201 shown in FIG. 2).

S36. when a second block to be rendered intersecting with said re-determined area to be rendered exists in the blocks to be rendered corresponding to the webpage update contents stored in said second preset storage area, transferring the webpage update contents corresponding to the second block to be rendered from said second preset storage area to said first preset storage area.

On the other hand, if no second block to be rendered exists, it indicates that, after the target webpage is scrolled, there is no area in the target webpage area displayed by the browser that needs to be rendered.

Since the rendering operation is only performed on webpage update contents stored in the second preset storage area, the webpage update contents corresponding to the second block to be rendered are transferred from said second preset storage area to said first preset storage area, thereby achieving the rendering of the second block to be rendered. Therefore, the present application caches the webpage update contents not in the range of the area to be rendered at the present moment to the second preset storage area, temporarily does not execute corresponding rendering operation, and executes the corresponding rendering operation only when the target webpage is scrolled to cause a corresponding area to enter the range of the area to be rendered; namely, the embodiment of the present application splits the update process of the entire target webpage into a plurality of discontinuous sub-processes, and each sub-process only updates a webpage area inside the visible area (and the expanded area) of the browser at a corresponding moment, which ensures the update speed of contents seen by users and eliminates a latency phenomenon of dynamic elements in the webpage.

FIG. 7 illustrates the time consumption comparison of webpage update processes on the same target webpage according to the prior art and the present application; wherein, 701 indicates the time consumption data of the browser kernel with an existing webpage update technology, 701 indicates the time consumption data of the browser shell with an existing webpage update technology, 703 indicates the time consumption data of the browser kernel in the present application, and 704 indicates the time consumption data of the browser shell in the present application.

By comparing data corresponding to 701 and 703 and data corresponding to 702 and 704 in FIG. 7, respectively, it can be seen that, relative to the existing webpage update technology, the time consumption by either the kernel or the shell for executing one rendering operation is significantly decreased after the application of the embodiment of the present application, and correspondingly, the number of times and the frequency of rendering are increased, such that the update speed of the target webpage is faster. As a result, the effect that can be seen by users is that the playback of animation and the response of screen sliding are more smooth with no latency phenomenon of irregular movement.

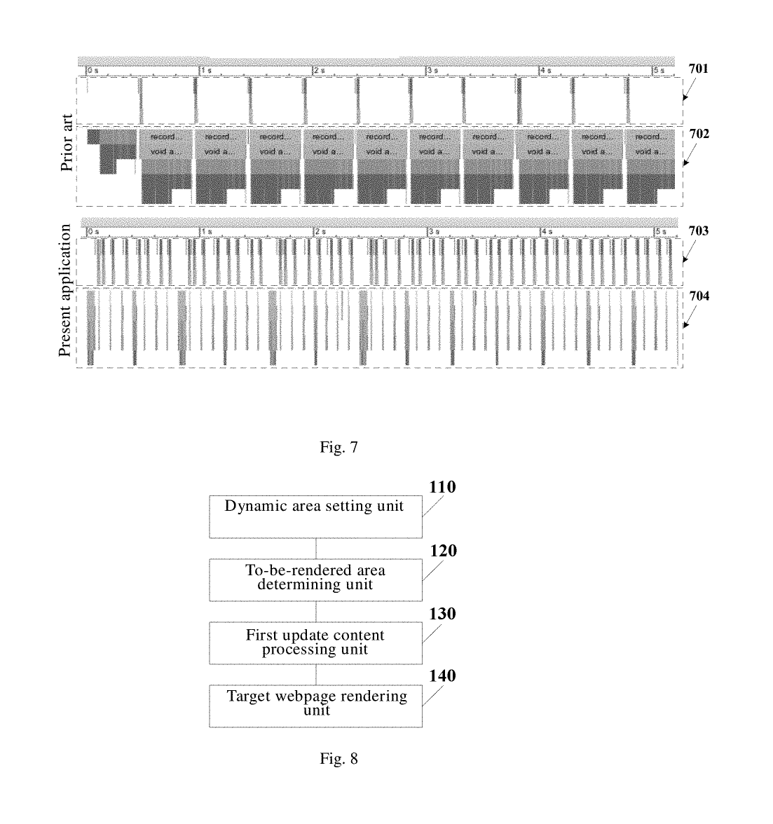

FIG. 8 is a structural block diagram of a webpage update device according to an embodiment of the present application, and said webpage update device is applied to an electronic device. Referring to FIG. 8, said device comprises: a dynamic area setting unit 110, a to-be-rendered area determining unit 120, a first update content processing unit 130 and a target webpage rendering unit 140.

The dynamic area setting unit 110 is configured to determine a dynamic area according to a visible area of a browser.

The to-be-rendered area determining unit 120 is configured to determine an area, corresponding to the dynamic area, in a target webpage as an area to be rendered.

The first update content processing unit 130 is configured to store webpage update contents corresponding to the area to be rendered into a first preset storage area.

The target webpage rendering unit 140 is configured to render the target webpage according to the webpage update contents stored in the first preset storage area.

It can be seen from the above technical solution that the embodiments of the present application first set a dynamic area according to a visible area of a browser, then use an area, corresponding to the dynamic area, in a target webpage as an area to be rendered, and store webpage update contents generated in the area to be rendered into a first preset storage area. Subsequently, the webpage update contents in said first preset storage area are read at one time, and the rendering of the area to be rendered is completed, which ensures that the content displayed in the current visible area is the updated content; meanwhile, webpage update contents generated in an area other than the area to be rendered are stored in a second preset storage area, and rendering of the corresponding area is temporarily not performed, which can reduce the workload of a rendering operation, and improve the rendering efficiency of the area to be rendered, thereby improving update speeds of dynamic elements such as a moving picture or an animation in the visible area, and eliminating a latency phenomenon of dynamic elements moving irregularly due to a slow update speed.

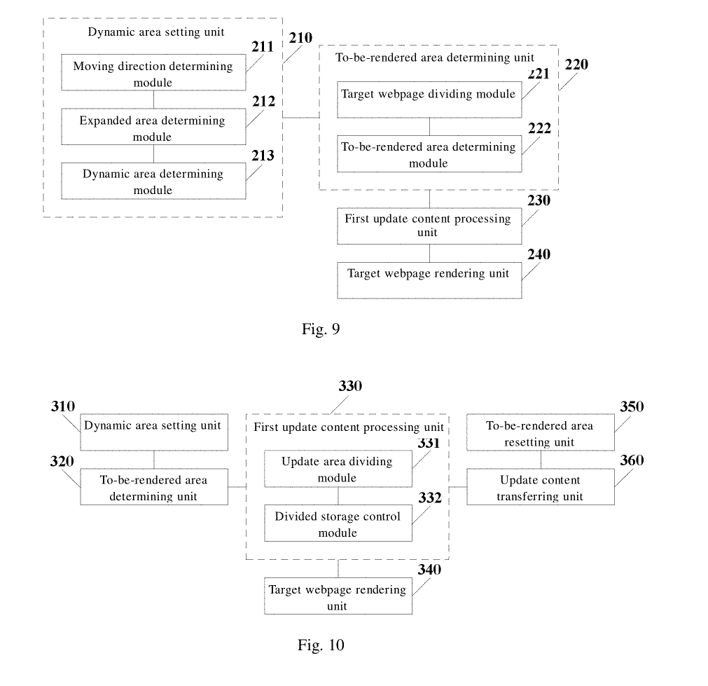

FIG. 9 is a structural block diagram of another webpage update device according to an embodiment of the present application. Referring to FIG. 9, said device comprises: a dynamic area setting unit 210, a to-be-rendered area determining unit 220, a first update content processing unit 230 and a target webpage rendering unit 240.

The above dynamic area setting unit 210 is configured to set a dynamic area according to a visible area of a browser. Said dynamic area setting unit 210 may comprise: a moving direction determining module 211, an expanded area determining module 212 and a dynamic area determining module 213.

Wherein, said moving direction determining module 211 is configured to determine a relative moving direction between said visible area and said target webpage.

Said expanded area determining module 212 is configured to determine an expanded area connected to said visible area according to said relative moving direction and a preset expansion height;

Said dynamic area determining module 213 is configured to determine an area formed by said visible area and said expanded area to be said dynamic area.

The above to-be-rendered area determining unit 220 is configured to determine an area, corresponding to the dynamic area, in a target webpage as an area to be rendered.

Wherein, said moving direction determining module comprises:

a coordinate system establishing sub-module configured to establish a Cartesian coordinate system on the plane on which the target webpage is located;

a relative moving mode determining sub-module configured to determine, according to changes of the top boundary coordinate of said visible area in said Cartesian coordinate system, a relative moving direction between said visible area and said target webpage.

The to-be-rendered area determining unit 220 comprises a target webpage dividing module 221 and a to-be-rendered area determining module 222.

Wherein, said target webpage dividing module 221 is configured to divide said target webpage into a plurality of static blocks;

said to-be-rendered area determining module 222 is configured to determine a static block intersecting with said dynamic area as an area to be rendered.

The above update content processing unit 230 is configured to store webpage update contents corresponding to the area to be rendered into a first preset storage area, and store other webpage update contents into a second preset storage area.

The above target webpage rendering unit 240 is configured to render the target webpage according to the webpage update contents stored in the first preset storage area.

Said target webpage dividing module is specifically configured to, in the height direction of said target webpage, divide said target webpage into a plurality of static blocks with the same height; alternatively, in the height direction of said target webpage, divide said target webpage into a plurality of static blocks with heights that are not all the same.

Furthermore, the above webpage update device may further comprise:

a storing module configured to store said static blocks with an array.

It can be seen from the above technical solution that the embodiments of the present application first determine an expanded area according to a relative moving direction between the visible area of the browser and the target webpage, then use a combination of the expanded area and the visible area as a dynamic area, and use a target webpage area intersecting with the dynamic area as an area to be rendered, such that said area to be rendered comprises both the target webpage area displayed in the browser at the present moment and a target webpage area to be displayed in the browser; then render the target webpage according to the webpage update contents corresponding to the area to be rendered, namely render the target webpage areas displayed and to be displayed in the browser, while webpage update contents of other areas are temporarily not processed, which can reduce the workload of the rendering operation at the present moment, improve the rendering speed, and also ensure that the target webpages displayed and to be displayed to users are successful rendered, thereby improving the update speed smoothness of contents seen by users.

FIG. 10 is a structural block diagram of a webpage update device according to an embodiment of the present application, and said webpage update device is applied to an electronic device. Referring to FIG. 10, said device comprises: a dynamic area setting unit 310, a to-be-rendered area determining unit 320, a first update content processing unit 330 and a target webpage rendering unit 340.

The dynamic area setting unit 310 is configured to determine a dynamic area according to a visible area of a browser.

The to-be-rendered area determining unit 320 is configured to determine an area, corresponding to the dynamic area, in a target webpage as an area to be rendered.

The first update content processing unit 330 is configured to store webpage update contents corresponding to the area to be rendered into a first preset storage area; said first update content processing unit 330 may comprise: an update area dividing module 331 and a divided storage control module 332.

Said update area dividing module 331 is configured to divide an area with webpage update contents in said target webpage into a plurality of blocks to be rendered;

Said divided storage control module 332 is configured to store webpage update contents of a first block to be rendered intersecting with said area to be rendered into said first preset storage area.

It should be noted that the above webpage update device may further comprise:

a second update content processing unit configured to store webpage update contents corresponding to an area other than the area to be rendered in said target webpage into a second preset storage area.

Specifically, said second update content processing unit stores webpage update contents of a block to be rendered other than said first block to be rendered into said second preset storage area.

Said target webpage rendering unit 340 is configured to render the target webpage according to the webpage update contents stored in the first preset storage area.

Referring to FIG. 10 again, the above webpage update device may further comprise: a to-be-rendered area resetting unit 350 and an update content transferring unit 360.

Said to-be-rendered area resetting unit 350 is configured to re-determine, when relative positions between said dynamic area and said target webpage change, said area to be rendered.

Said update content transferring unit 360 is configured to transfer, when a second block to be rendered intersecting with said re-determined area to be rendered exists in the blocks to be rendered corresponding to the webpage update contents stored in said second preset storage area, the webpage update contents corresponding to the second block to be rendered from said second preset storage area to said first preset storage area.

It can be seen from the above technical solution that, in the embodiment of the present application, the rendering operation is only performed on webpage update contents stored in the second preset storage area. When the webpage update contents corresponding to the second block to be rendered are transferred from said second preset storage area to said first preset storage area, therefore, the rendering of the second block to be rendered can be achieved. Therefore, the present application caches the webpage update contents not in the range of the area to be rendered at the present moment to the second preset storage area, temporarily does not execute corresponding rendering operation, and executes the corresponding rendering operation only when the target webpage is scrolled to cause a corresponding area to enter the range of the area to be rendered; namely, the embodiment of the present application splits the update process of the entire target webpage into a plurality of discontinuous sub-processes, and each sub-process only updates a webpage area inside the visible area (and the expanded area) of the browser at a corresponding moment, which ensures the update speed of contents seen by users and eliminates a latency phenomenon of dynamic elements in the webpage.

With respect to the devices in the above embodiments, specific modes of operation execution by each module thereof have been described in detail in the embodiments related to said method, which will not be described in detail herein.

In addition, the embodiment of the present application further provides a computer storage medium, which may be, for example, ROM, Random Access Memory (RAM), CD-ROM, a magnetic tape, a floppy disk, and an optical data storage apparatus; a program is stored in said computer storage medium. When the program in said storage medium is executed by a processor of an electronic device, the electronic device is caused to execute a part of or all the steps in the webpage update method set forth in the above method embodiment.

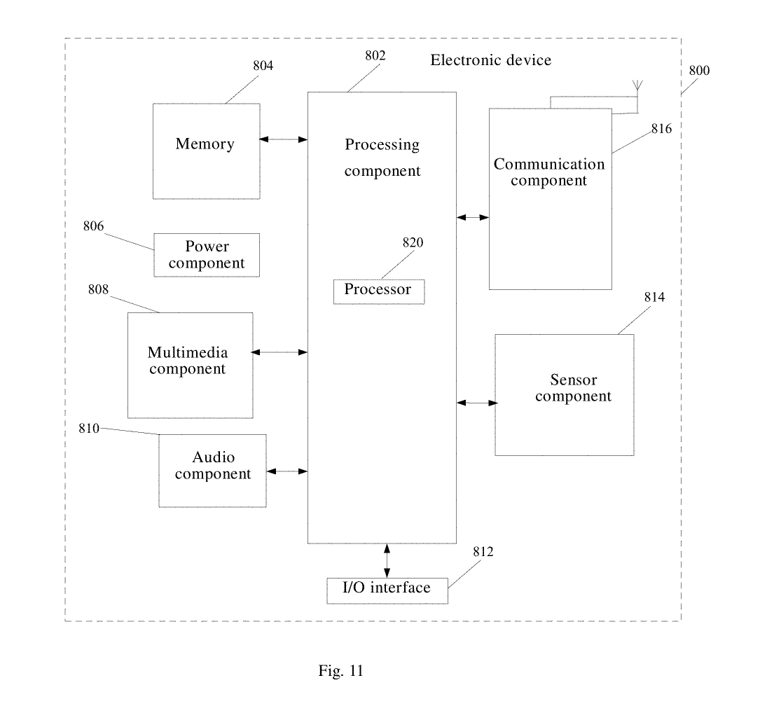

FIG. 11 is a structural block diagram of an electronic device 800 according to an exemplary embodiment. For example, the electronic device 800 may be a mobile phone, a tablet device, a laptop computer, a digital broadcasting terminal, a message receiving and transmitting device, and the like.

Referring to FIG. 11, the electronic device 800 may comprise the following one or more components: a processing component 802, a memory 804, a power component 806, a multimedia component 808, an audio component 810, an I/O interface 812, a sensor component 814, and a communication component 816.

The processing component 802 usually controls the overall operation of the electronic device 800, such as operations related to display, phone call, data communication, camera operation and recording operation. The processing component 802 may comprise one or more processors 820 to execute local or remote instructions to complete a part of or all steps in the above method. In addition, the processing component 802 may comprise one or more modules to facilitate interactions between the processing component 802 and other components. For example, the processing component 802 may comprise a multimedia module to facilitate interactions between the multimedia component 808 and the processing component 802.

The memory 804 is configured to store various types of data to support operations on the electronic device 800. Examples of these data include instructions of any application or method, contact data, phonebook data, messages, photos, videos and the like for operations on the electronic device 800. The memory 804 may be implemented by any type of volatile or non-volatile storage devices or combinations thereof, such as a Static RAM (SRAM), an Electrically Erasable Programmable Read-Only Memory (EEPROM), an Erasable Programmable Read-Only Memory

(EPROM), a Programmable Read-Only Memory (PROM), a Read-Only Memory (ROM), a magnetic memory, a flash memory, a magnetic disk or an optical disk.

The power component 806 provides power to all components of the electronic device 800. The power component 806 may comprise a power management system, one or more power sources, and other components associated with the generation, management and distribution of power for the electronic device 800.

The multimedia component 808 comprises a screen that provides an output port between the electronic device 800 and a user. In some embodiments, the screen may comprise a liquid crystal display (LCD) and a touchscreen panel (TP). If the screen comprises a touchscreen panel, the screen may be implemented as a touchscreen for receiving input signals from a user. The touchscreen comprises one or more touch sensors to sense touch, sliding and gestures on the touchscreen panel. Said touch sensors not only can sense boundaries of touching or sliding actions, but also can detect the duration and pressure associated with said touching or sliding operations. In some embodiments, the multimedia component 808 comprises a front camera and/or a rear camera. When the electronic device 800 is in an operating mode, such as a photo shooting mode or a video mode, the front camera and/or the rear camera can receive external multimedia data, and each of the front camera and the rear camera may be a fixed optical lens system or have focusing and optical zooming capabilities.

The audio component 810 is configured to input and/or output audio signals. For example, the audio component 810 comprises a microphone (MIC), and when the electronic device 800 is in an operating mode, such as a calling mode, a recording mode or a speech recognition mode, the MIC is configured to receive external audio signals. The received audio signals can be further stored in the memory 804 or sent via the communication component 816. In some embodiments, the audio component 810 further comprises a loudspeaker for outputting audio signals.

The I/O interface 812 provides an interface between the processing component 802 and a peripheral interface module. The above peripheral interface module may be a keyboard, a click wheel, a button and the like. These buttons may include, but are not limited to, homepage button, volume button, activation button and lock button.

The sensor component 814 comprises one or more sensors to provide state evaluation on all aspects to the electronic device 800. For example, the sensor component 814 can detect the on/off state of the electronic device 800, relative positioning of the components, such as said components being a display and a small keyboard of the electronic device 800, and the sensor component 814 can further detect position changes of the electronic device 800 or a component of the electronic device 800, presence or absence of contact between a user and the electronic device 800, position or acceleration/deceleration of the electronic device 800, and temperature changes of the electronic device 800. The sensor component 814 may comprise a proximity sensor, which is configured to detect the presence of nearby objects when there is no physical contact. The sensor component 814 may further comprise an optical sensor, such as a CMOS or CCD image sensor, which is configured for use in imaging applications. In some embodiments, said sensor component 814 may further comprise an acceleration sensor, a gyroscope sensor, a magnetic sensor, a pressure sensor or a temperature sensor.

The communication component 816 is configured to facilitate the wired or wireless communications between the electronic device 800 and other devices. The electronic device 800 may be connected into a wireless network based on the communications standards, such as Wi-Fi, 2G, 3G or a combination thereof. In an exemplary embodiment, the communication component 816 receives a broadcasting signal or broadcasting-related information from an external broadcasting management system via a broadcasting channel. In an exemplary embodiment, the communication component 816 further comprises a near field communication (NFC) module to promote short-distance communication. For example, the NFC module may be implemented based on the radio frequency identification (RFID) technology, the Infrared Data Association (IrDA) technology, the Ultra Wideband (UWB) technology, the Bluetooth technology and other technologies.

In an exemplary embodiment, the electronic device 800 may be implemented by one or more application-specific integrated circuits (ASIC), digital signal processors (DSP), digital signal processing devices (DSPD), programmable logic devices (PLD), field-programmable gate arrays (FPGA), controllers, micro-controllers, micro-processors, or other electronic parts to execute the above positioning information collection method.

Wherein, in the present embodiment, the processor 820 can complete the following steps by executing instructions in the memory 804:

determining a dynamic area according to a visible area of a browser;

determining an area, corresponding to the dynamic area, in a target webpage as an area to be rendered;

storing webpage update contents corresponding to the area to be rendered into a first preset storage area;

rendering the target webpage according to the webpage update contents stored in the first preset storage area.

In a feasible implementation mode of the present application, to implement the determining a dynamic area according to a visible area of a browser, the processor 820 can execute the following steps:

determining a relative moving direction between said visible area and said target webpage;

determining an expanded area connected to said visible area according to said relative moving direction and a preset expansion height;

determining an area formed by said visible area and said expanded area to be said dynamic area.

In another feasible implementation mode of the present application, the processor 820 specifically establishes a Cartesian coordinate system on the plane on which the target webpage is located; according to changes of the top boundary coordinate of said visible area in said Cartesian coordinate system, determines a relative moving direction between said visible area and said target webpage.

In another feasible implementation mode of the present application, to determine an area, corresponding to the dynamic area, in a target webpage as an area to be rendered, the processor 820 can execute the following steps:

dividing said target webpage into a plurality of static blocks;

determining a static block intersecting with said dynamic area as an area to be rendered.

Specifically, the processor can, in the height direction of said target webpage, divide said target webpage into a plurality of static blocks with the same height; alternatively, in the height direction of said target webpage, divide said target webpage into a plurality of static blocks with heights that are not all the same. In addition, it can store said static blocks with an array.

In another feasible implementation mode of the present application, to store webpage update contents corresponding to the area to be rendered into a first preset storage area, the processor 820 can execute the following steps:

dividing an area with webpage update contents in said target webpage into a plurality of blocks to be rendered;

storing webpage update contents of a first block to be rendered intersecting with said area to be rendered into said first preset storage area.

In another feasible implementation mode of the present application, the processor 820 can further execute the following step: storing webpage update contents corresponding to an area other than the area to be rendered in said target webpage into a second preset storage area.

Specifically, the processor 820 stores webpage update contents corresponding to an area other than the area to be rendered webpage into a second preset storage area.

In another feasible implementation mode of the present application, the processor 820 can further execute the following steps:

when relative positions between the dynamic area and the target webpage change, re-determining said area to be rendered;

when a second block to be rendered intersecting with said re-determined area to be rendered exists in the blocks to be rendered corresponding to the webpage update contents stored in said second preset storage area, transferring the webpage update contents corresponding to the second block to be rendered from said second preset storage area to said first preset storage area.

In a specific implementation, the present application further provides a computer storage medium, wherein a program is stored in said computer storage medium. When the program is executed, it may comprise a part of or all the steps in all embodiments of the webpage update method according to the present invention. The storage medium may be a magnetic disk, an optical disk, a Read-Only Memory (ROM), or a Random-Access Memory (RAM).

Upon considering the description and implementing the invention disclosed herein, it would be easy for those skilled in the art to conceive of other implementations of the present invention. The present application intends to cover any variations, uses or adaptive changes of the present invention. These variations, uses or adaptive changes follow the general principle of the present invention and comprise common general knowledge or common technical means in the art that are not disclosed by the present application. The description and embodiments are only deemed exemplary. The true scope and spirit of the present invention are defined by the appended claims.

It should be understood that the present invention is not limited by the accurate structures described above and illustrated in the accompanying drawings, and various amendments and modifications can be made without departing from the scope thereof. The scope of the present invention is only subject to the appended claims.

1. A webpage update method, characterized in that said method is applied to a browser and comprises:
determining a dynamic area according to a visible area of the browser;
determining an area, corresponding to the dynamic area, in a target webpage as an area to be rendered;
storing webpage update contents corresponding to the area to be rendered into a first preset storage area; and
rendering the target webpage according to the webpage update contents stored in the first preset storage area.

2. The webpage update method according to claim 1, characterized in that said determining the dynamic area according to the visible area of the browser comprises:
determining a relative moving direction between said visible area and said target webpage;
determining an expanded area connected to said visible area according to said relative moving direction and a preset expansion height; and
determining an area formed by said visible area and said expanded area to be said dynamic area.

3. The webpage update method according to claim 2, characterized in that said determining the relative moving direction between said visible area and said target webpage comprises:
establishing a Cartesian coordinate system on a plane on which the target webpage is located; and
according to changes of a top boundary coordinate of said visible area in said Cartesian coordinate system, determining the relative moving direction between said visible area and said target webpage.

4. The webpage update method according to claim 1, characterized in that said determining the area, corresponding to the dynamic area, in the target webpage as the area to be rendered comprises:
dividing said target webpage into a plurality of static blocks; and
determining a static block intersecting with said dynamic area as the area to be rendered.

5. The webpage update method according to claim 4, characterized in that said dividing said target webpage into the plurality of static blocks comprises:
in a height direction of said target webpage, dividing said target webpage into a plurality of static blocks with a same height; or alternatively,
in the height direction of said target webpage, dividing said target webpage into a plurality of static blocks with heights that are not all the same.

6. The webpage update method according to claim 4, characterized in that said method further comprises:
storing said plurality of static blocks with an array.

7. The webpage update method according to claim 1, characterized in that said method further comprises:
storing webpage update contents corresponding to an area other than the area to be rendered in said target webpage into a second preset storage area.

8. The webpage update method according to claim 7, characterized in that said storing the webpage update contents corresponding to the area to be rendered into the first preset storage area comprises:
dividing an area with webpage update contents in said target webpage into a plurality of blocks to be rendered; and
storing webpage update contents of a first block to be rendered intersecting with said area to be rendered into said first preset storage area.

9. The webpage update method according to claim 8, characterized in that said storing webpage update contents corresponding to the area other than the area to be rendered in said target webpage into the second preset storage area comprises:
storing webpage update contents of a block to be rendered other than said first block to be rendered into said second preset storage area.

10. The webpage update method according to claim 9, characterized in that said method further comprises:
when relative positions between said dynamic area and said target webpage change, re-determining said area to be rendered; and
when a second block to be rendered intersecting with said re-determined area to be rendered exists in the blocks to be rendered corresponding to the webpage update contents stored in said second preset storage area, transferring the webpage update contents corresponding to the second block to be rendered from said second preset storage area to said first preset storage area.

11. A webpage update device comprising:
a dynamic area setting unit, configured to determine a dynamic area according to a visible area of a browser;
a to-be-rendered area determining unit, configured to determine an area, corresponding to the dynamic area, in a target webpage as an area to be rendered;
a first update content processing unit, configured to store webpage update contents corresponding to the area to be rendered into a first preset storage area; and
a target webpage rendering unit, configured to render the target webpage according to the webpage update contents stored in the first preset storage area.

12. The webpage update device according to claim 11, characterized in that said dynamic area setting unit comprises:
a moving direction determining module, configured to determine a relative moving direction between said visible area and said target webpage;
an expanded area determining module, configured to determine an expanded area connected to said visible area according to said relative moving direction and a preset expansion height; and
a dynamic area determining module, configured to determine an area formed by said visible area and said expanded area to be said dynamic area.

13. The webpage update device according to claim 12, characterized in that said moving direction determining module comprises:
a coordinate system establishing sub-module, configured to establish a Cartesian coordinate system on a plane on which the target webpage is located; and
a relative moving mode determining sub-module, configured to determine, according to changes of a top boundary coordinate of said visible area in said Cartesian coordinate system, the relative moving direction between said visible area and said target webpage.

14. The webpage update device according to claim 11, characterized in that said to-be-rendered area determining unit comprises:
a target webpage dividing module, configured to divide said target webpage into a plurality of static blocks; and
a to-be-rendered area determining module, configured to determine a static block intersecting with said dynamic area as the area to be rendered.

15. The webpage update device according to claim 14, characterized in that said target webpage dividing module is specifically configured to:
in a height direction of said target webpage, divide said target webpage into a plurality of static blocks with a same height; alternatively,
in the height direction of said target webpage, divide said target webpage into a plurality of static blocks with heights that are not all the same.

16. The webpage update device according to claim 14, characterized in that said device comprises:
a storing module configured to store said plurality of static blocks with an array.

17. The webpage update device according to claim 11, characterized in that said device further comprises:
a second update content processing unit, configured to store webpage update contents corresponding to an area other than the area to be rendered in said target webpage into a second preset storage area.

18. The webpage update device according to claim 17, characterized in that said first update content processing unit comprises:
an update area dividing module, configured to divide an area with webpage update contents in said target webpage into a plurality of blocks to be rendered; and
a divided storage control module, configured to store webpage update contents of a first block to be rendered intersecting with said area to be rendered into said first preset storage area.

19. The webpage update device according to claim 18, characterized in that said second update content processing unit is specifically configured to:
store webpage update contents of a block to be rendered other than said first block to be rendered into said second preset storage area.

20. The webpage update device according to claim 19, characterized in that said device further comprises:
a to-be-rendered area resetting unit, configured to re-determine, when relative positions between said dynamic area and said target webpage change, said area to be rendered; and
an update content transferring unit, configured to transfer, when a second block to be rendered intersecting with said re-determined area to be rendered exists in the blocks to be rendered corresponding to the webpage update contents stored in said second preset storage area, the webpage update contents corresponding to the second block to be rendered from said second preset storage area to said first preset storage area.

21. An electronic device comprising:
a processor; and
a non-transitory memory configured to store an instruction executable by said processor, the non-transitory memory and the instruction configured to, with the processor, cause the electronic device to at least:
set a dynamic area according to a visible area of a browser;
determine an area, corresponding to the dynamic area, in a target webpage as an area to be rendered;
store webpage update contents corresponding to the area to be rendered into a first preset storage area; and
render the target webpage according to the webpage update contents stored in the first preset storage area.

22. The electronic device according to claim 21, characterized in that the non-transitory memory and the instruction are further configured to, with the processor, cause the electronic device to:
determine a relative moving direction between said visible area and said target webpage;
determine an expanded area connected to said visible area according to said relative moving direction and a preset expansion height; and
determine an area formed by said visible area and said expanded area to be said dynamic area.

23. The electronic device according to claim 21, characterized in that the non-transitory memory and the instruction are further configured to, with the processor, cause the electronic device to:
establish a Cartesian coordinate system on a plane on which the target webpage is located; and
according to changes of a top boundary coordinate of said visible area in said Cartesian coordinate system, determine the relative moving direction between said visible area and said target webpage.

24. The electronic device according to claim 21, characterized in that the non-transitory memory and the instruction are further configured to, with the processor, cause the electronic device to:
divide said target webpage into a plurality of static blocks; and
determine a static block intersecting with said dynamic area as the area to be rendered.

25. The electronic device according to claim 24, characterized in that the non-transitory memory and the instruction are further configured to, with the processor, cause the electronic device to:
divide, in a height direction of said target webpage, said target webpage into a plurality of static blocks with a same height; alternatively,
in the height direction of said target webpage, divides said target webpage into a plurality of static blocks with heights that are not all the same.

26. The electronic device according to claim 24, characterized in that the non-transitory memory and the instruction are further configured to, with the processor, cause the electronic device to store said plurality of static blocks with an array.

27. The electronic device according to claim 24, characterized in that the non-transitory memory and the instruction are further configured to, with the processor, cause the electronic device to store webpage update contents corresponding to an area other than the area to be rendered in said target webpage into a second preset storage area.

28. The electronic device according to claim 27, characterized in that the non-transitory memory and the instruction are further configured to, with the processor, cause the electronic device to:
divide an area with webpage update contents in said target webpage into a plurality of blocks to be rendered; and
store webpage update contents of a first block to be rendered intersecting with said area to be rendered into said first preset storage area.

29. The electronic device according to claim 28, characterized in that the non-transitory memory and the instruction are further configured to, with the processor, cause the electronic device to store webpage update contents corresponding to an area other than the area to be rendered into a second preset storage area.

30. The electronic device according to claim 29, characterized in that the non-transitory memory and the instruction are further configured to, with the processor, cause the electronic device to:
re-determine, when relative positions between said dynamic area and said target webpage change, said area to be rendered; and
if a second block to be rendered intersecting with said re-determined area to be rendered exists in the blocks to be rendered corresponding to the webpage update contents stored in said second preset storage area, transfer the webpage update contents corresponding to the second block to be rendered from said second preset storage area to said first preset storage area.

31. (canceled)
